(19) United States
(12) Patent Application Publication
(10) Pub. No.: US 2001/0007131 A1
(43) Pub. Date: Jul. 5, 2001

(54) METHOD FOR VALIDATING EXPANSION ROMS USING CRYPTOGRAPHY

(76) Inventors: LEONARD J. GALASSO, RANCHO SANTA MARGARITA, CA (US); SON VU, HUNTINGTON BEACH, CA (US); QUANG PHAN, TUSTIN, CA (US)

Correspondence Address: KIMBERLEY G. NOBELS, IRELL & MANELLA, LLP, 840 NEWPORT CENTER DRIVE, SUITE 400, NEWPORT BEACH, CA, 92660, US

(21) Appl. No.: 08/927,934

(22) Filed: Sep. 11, 1997

(51) Int. Cl. G06F 12/14

(52) U.S. Cl. 713/187; 713/189

(57) ABSTRACT

A method for validating expansion ROM cards which are loaded into a Personal Computer. A ROM image is signed (encrypted) using a private key and an encryption algorithm to create a digital signature. The digital signature is stored along with the ROM image on an expansion ROM. The system BIOS scans the system for the presence of an expansion ROM and when one is detected, the digital signature is verified (decrypted) using a public key corresponding to the private key. If the decrypted digital signature matches the ROM image (or a hash digest thereof), then the BIOS loads the ROM image.

### BACKGROUND OF THE INVENTION

1. Field of the Invention

The present invention relates generally to the field of computer security, and more particularly, to a method for validating third-party expansion ROMs in a personal computer using cryptography.

2. Description of Related Art

The original IBM Personal Computer (PC) Basic Input Output System (BIOS) architecture allowed for the inclusion into the system of third-party expansion ROMs—ROMs that share the address space with BIOS, but which are not actually part of the PC BIOS. These third-party expansion ROMs may be present on system plug-in cards, for example. During system initialization, the system BIOS “scans” the proscribed address spaces, looking for a simple byte pattern that designates the start of an expansion ROM. If such a pattern is encountered, the BIOS performs a simple checksum on the ROM image and if the result is correct, the BIOS executes the program contained in the ROM by jumping to an entry point located on a known boundary.

This procedure for loading expansion ROMs generally works fine in an unsecured environment. However, since the expansion ROM's program is executed without regard for its origin or content, a destructive agent, virus, or program may be introduced into the system during initialization. The security problem has recently become more acute with the advent and proliferation of so-called “temporal devices”, i.e., devices which are introduced into the system after normal operating-system initialization.

The emerging HOT-PLUG PCI standard, which allows for the so-called “Hot Insertion” of a device (inserting a device into a live, powered-up bus, while an operating system is still running), will require that a system agent, in order to detect and configure the device, scan the device for valid expansion ROMs. Without proper security countermeasures, serious system-security compromises may occur. This is especially true in network or file server configurations in which system security is of paramount importance. Hot Insertion will soon be a viable feature which will allow system operators to make dynamic system hardware changes to a server without bringing down the whole network. Therefore, there is a need for a security method for validating expansion ROMs to ensure system integrity.

### OBJECTS AND SUMMARY OF THE INVENTION

The present invention is a method for validating expansion ROMs using cryptography. A ROM image is signed (encrypted) using a private key to create a digital signature. The digital signature is stored along with the ROM image on the ROM. A system BIOS scans the system for the presence of an expansion ROM and when one is detected, the digital signature stored on the ROM is verified (decrypted) using a public key corresponding to the private key. If the verified digital signature matches the ROM image contained on the ROM (or a hashed digest thereof), the BIOS proceeds to load the ROM image.

A first embodiment of the present invention allows each ROM vendor to use its own private encryption key. The system BIOS then stores a public key corresponding to each ROM vendor's private key in a BIOS database. When an expansion ROM is detected by the system BIOS, each public key is used to verify the ROM until a match occurs, or until all the public keys have been tried.

In a second embodiment of the present invention, the BIOS vendor digitally signs all the ROM images using its own private key. According to this embodiment, only the public key corresponding to the BIOS vendor's private key needs to be stored in the BIOS and used to verify the expansion ROMs.

### BRIEF DESCRIPTION OF THE DRAWINGS

The exact nature of this invention, as well as its objects and advantages, will become readily apparent from consideration of the following specification as illustrated in the accompanying drawing, and wherein:

FIG. 1 is a flowchart depicting a simplified prior-art insecure ROM scan procedure;

FIG. 2 is a block diagram illustrating the process of signing a ROM image according to a first embodiment of the present invention;

FIG. 3 is a block diagram illustrating BIOS authentication processing of a signed ROM image according to the first embodiment of the present invention;

FIG. 4 is a flowchart depicting the simplified ROM scan procedure with the additional processing according to the first embodiment of the present invention;

FIG. 5 is a block diagram illustrating the process of signing a ROM image according to a second embodiment of the present invention;

FIG. 6 is a block diagram illustrating BIOS authentication processing of a signed ROM image according to the second embodiment of the present invention;

FIG. 7 is a flowchart depicting the simplified ROM scan procedure with the additional processing according to the second embodiment of the present invention.

### DETAILED DESCRIPTION OF THE PREFERRED EMBODIMENTS

The following description is provided to enable any person skilled in the art to make and use the invention and sets forth the best modes contemplated by the inventors for carrying out the invention. Various modifications, however, will remain readily apparent to those skilled in the art, since the basic principles of the present invention have been defined herein specifically to provide a method for validating expansion ROMs using cryptography.

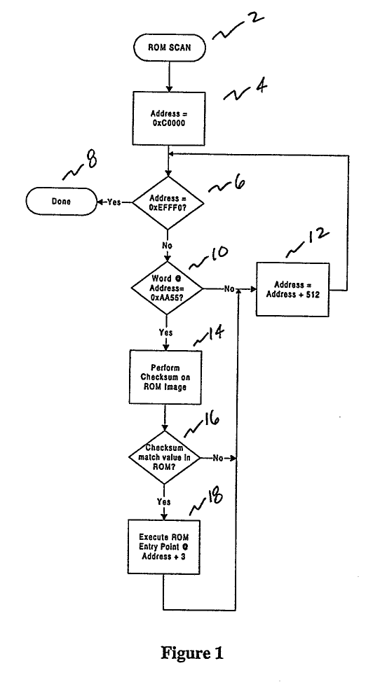

FIG. 1 depicts a process flow of a simplified prior-art ROM scan procedure. During a system boot-up procedure, the system BIOS scans a personal computer (PC) for the presence of any expansion ROMs at step 2. The scan begins (step 4) at address 0xC0000, which is the first possible address for an expansion ROM. This address is an IBM-compatible PC convention and is used universally throughout the PC industry. A boundary check is performed at step 6. If the current address to be scanned is equal to 0xEFFF0, then there are no more expansion ROMs to be scanned. By industry convention, this boundary address is the end of the possible expansion space. Once the entire expansion space has been scanned, the process flow ends at step 8. However, if the current address is still within valid expansion ROM address space, then at step 10 the value of the word stored at the current address is compared to the value 0xAA55. The word value is a signature which indicates that the following address space contains expansion ROM code. Again, this signature value is a conventional industry standard.

If the signature value is not present at the current address, then the address is incremented by 512 at step 12. By industry convention, the expansion ROMs may begin on 512 byte boundaries. The boundary check at step 6 is again performed and the value of the word located at this new address is compared to the signature value. If the signature value matches the value of the word at the current address, then a checksum is performed on the ROM image at step 14. If the calculated checksum matches a checksum value stored on the ROM (step 16), then the ROM image is executed beginning at three bytes after the current address (step 18). If the checksum values do not match, the process continues at step 12. Likewise, once a ROM image is loaded, the process continues to scan for more ROMs at step 12 until the boundary check condition is met at step 6.

Note that ordinarily the ROM scan procedure is executed only during the system boot procedure. However, with the advent of hot insertion devices, the ROM scan procedure may be performed upon the detection of the presence of an expansion ROM card, even after the system has already been initialized.

As described, the ROM scan procedure will load any ROM image which contains the standard signature in the correct location, and which passes the simple checksum test. However, the ROM image may contain security breaching code or viruses which will have a harmful effect on the computer system. Therefore, it is desirable to provide a more secure ROM scan process to insure that only valid and approved expansion ROMs are loaded by the system BIOS.

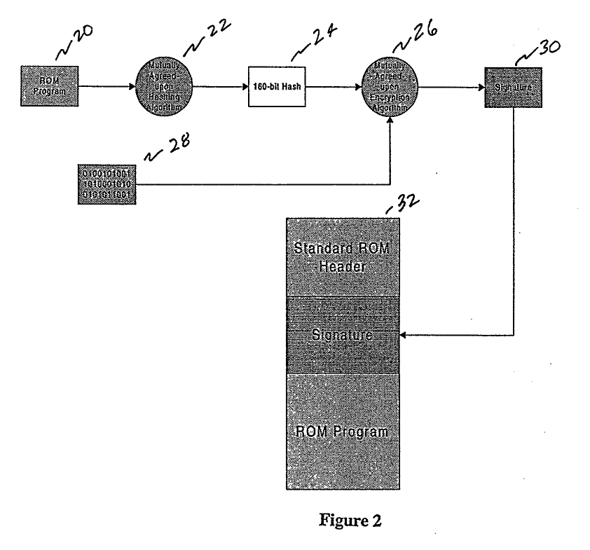

The first embodiment of the present invention is illustrated in FIGS. 2-4. The following method utilizes a cryptographic process which has both a public key and a private key component. Crypto processes which have a public key and private key are also known as “assymetric” cryptography. One example of such a cryptographic process is the PGP algorithm, which is well known in the cryptographic art. The cryptographic engine may be enabled within a secure processor mode and an associated secure memory area as described in a related patent application entitled “METHOD AND APPARATUS FOR SECURE PROCESSING OF CRYPTOGRAPHIC KEYS” Serial No. , and commonly assigned to the assignee of the present invention. The disclosure of this application is herein incorporated by reference.

The cryptographic engine is used to create and detect the presence of a so-called “digital signature” embedded within a ROM image. A valid digital signature can only be created by a holder of a valid secret key and verified by a holder of the corresponding public key.

FIG. 2 illustrates the process of signing the ROM image using a private key. Using a mutually-agreed-upon encryption method, such as the PGP algorithm, the public and private keys (key pairs) are generated by an expansion ROM vendor, who maintains the secrecy of the private key. Both the BIOS vendor and the expansion ROM vendors need to mutually agree upon which encryption method to use, in order for the procedure to work correctly. The public key is included in a BIOS database (typically a non-volatile memory) contained on the system. The expansion ROM vendor, using an agreed-upon hashing algorithm 22, hashes the salient portions of the expansion ROM image 20, producing a small hash product 24. A hash algorithm is used to reduce the size of the resulting digital signature, while still providing a high level of security. In this embodiment, a 160-bit hashing algorithm is used, but any agreed upon algorithm may be used. Both the BIOS vendor and the ROM vendors need to mutually agree upon a hashing algorithm before implementing the present invention. This hash product 24 is then signed by the expansion ROM vendor, using its private key 28 and a mutually agreed upon encryption algorithm 26. The resulting output is known as a “digital signature” 30. This encryption processing may be performed in a protected environment as described in the above-identified application entitled “METHOD AND APPARATUS FOR SECURE PROCESSING OF CRYPTOGRAPHIC KEYS.” The digital signature 30 is then stored along with the original ROM program on the expansion ROM 32.

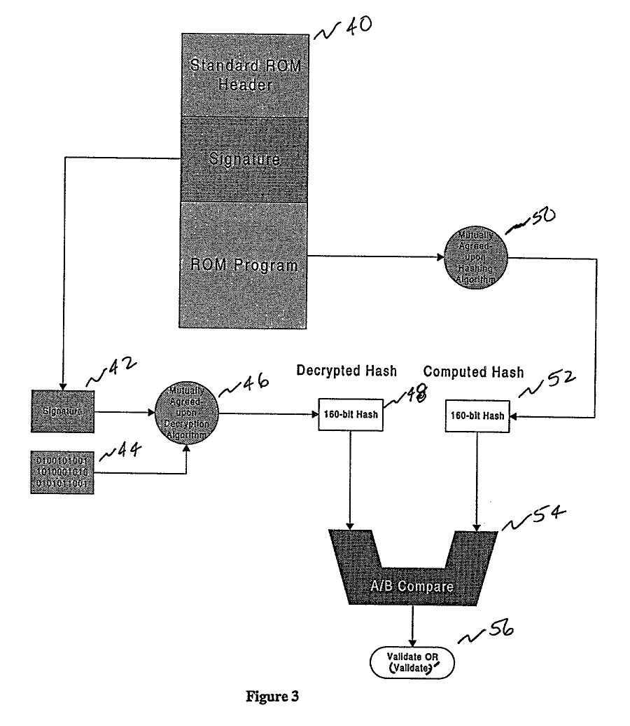

FIG. 3 illustrates the authentication process of an expansion ROM constructed according to the first embodiment of present invention. First, using the signed ROM image 40, the system BIOS generates a hash product 52 of the ROM program using the mutually agreed upon 160-bit hashing algorithm 50. Next, the digital signature 42 is decrypted using one of the public keys 44 embedded within a non-volatile storage on the system. The non-volatile storage stores a public key corresponding to each ROM vendor's private key. If the decryption algorithm 46, using any one of the public keys 44 stored on the system, produces a decrypted hash product 48 which matches bit-for-bit the computed hash product 52 of the ROM program, then the associated ROM program is considered authenticated and secure. The ROM program beginning at the ROM's entry point may then be executed.

Note that only a private key which corresponds to one of the public keys stored in the non-volatile storage will produce a valid signature. Thus, by keeping the private keys secret, only authorized expansion cards manufactured by authorized vendors will be recognized and loaded.

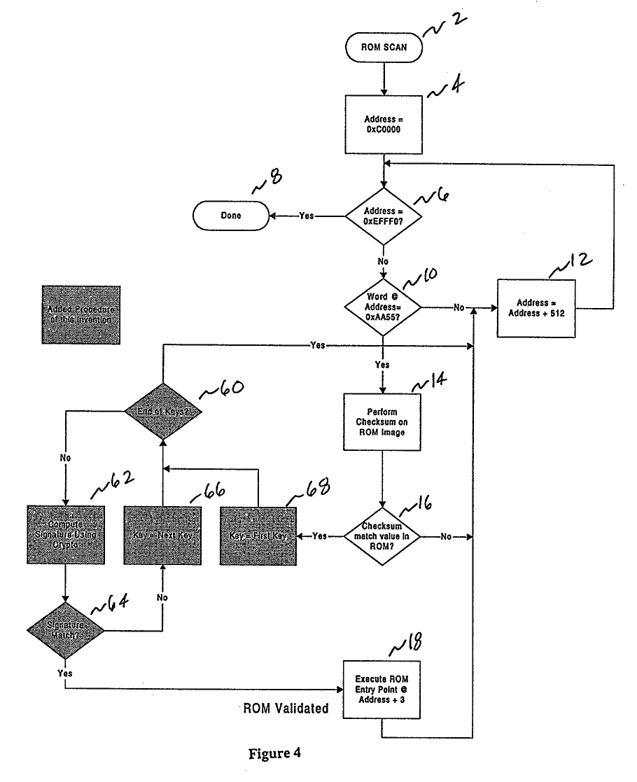

FIG. 4 depicts the simplified ROM scan process of FIG. 1 with the additional steps required to validate the ROM program according to the first embodiment of the present invention. The additional steps are shown in darker shades. The operation of steps 2-14 are identical to the operation of the corresponding steps in FIG. 1 and a description of these steps will not be repeated here. Beginning at step 16, if there is a checksum match, the variable “key” is set to the value “first key” at step 68, otherwise the normal process continues at step 12.

After step 68, the processing enters the key processing loop. If all the available keys have been processed at step 60, then the normal processing continues at step 12. If there are remaining keys to process, then at step 62 the digital signature of the current ROM image is decrypted using the present public key. If the decrypted signature matches the hashed ROM image, then the ROM image is executed at step 18. If the decrypted signature does not match the hashed ROM image, however, then the next public key stored in the non-volatile storage is used at step 66. If all the keys have been used, and there is still no match, the key processing loop exits at step 60 and the normal processing continues at step 12. Thus, if an expansion ROM is inserted into the system, without the proper digital signature, the associated ROM image will not be executed during the ROM scan process. This protects the system from loading unauthorized expansion ROMs which may cause system malfunctions by introducing viruses or security breaching code into the system.

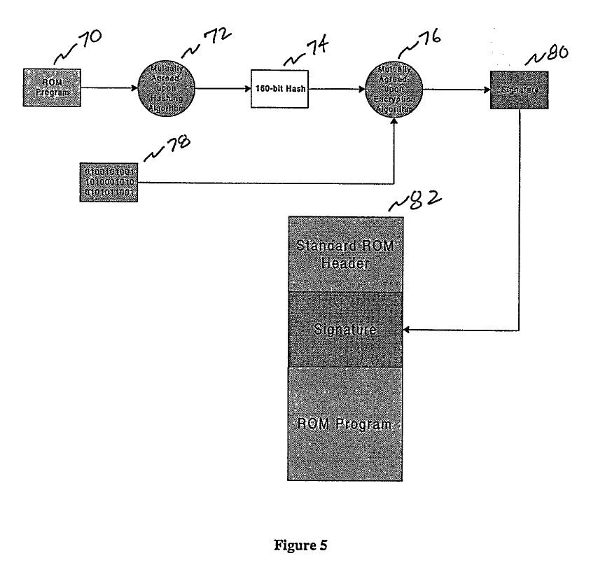

FIG. 5 illustrates a second embodiment of the present invention. This second embodiment differs from the first embodiment in that the third-party ROM vendor must first send the ROM program 70 to the BIOS vendor. The BIOS vendor then generates the same type of hash digest 74 of the ROM image 70 as is used in the first embodiment, using the same type of agreed upon 160-bit hashing algorithm 72. The BIOS vendor then signs the digest 74 by encrypting the digest 74 with its own private key 78. The signed, encrypted digest 80 is then sent back to the third-party expansion ROM vendor, who then integrates the signature into a new ROM image 82 before manufacturing.

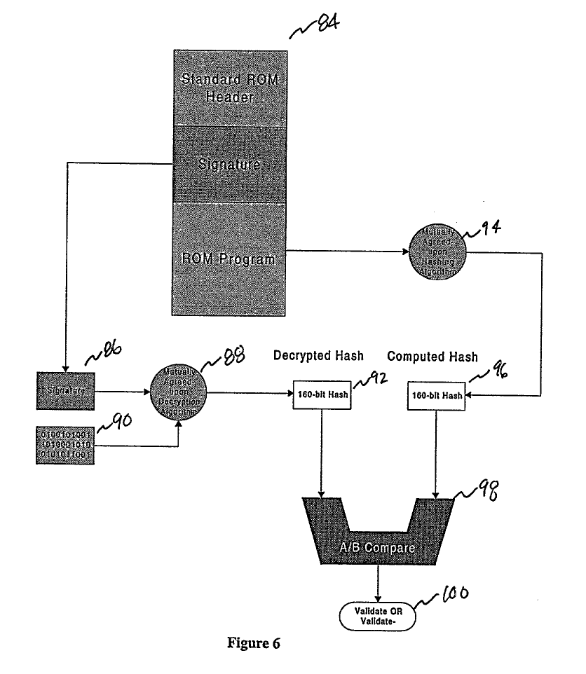

The authentication process for the second embodiment of the present invention is shown in FIG. 6. At runtime, the system BIOS authenticates the ROM image 84 by decrypting the signature portion, using the agreed-upon decryption algorithm 88 and the BIOS vendor's public key 90. The ROM program is also hashed using the mutually agreed upon hashing algorithm 94. If the decrypted digest 92 matches (A/B compare 98) bit-for-bit with the hashed digest 96, then the program is considered validated and safe to execute; otherwise it is considered invalidated and it is not executed (step 100).

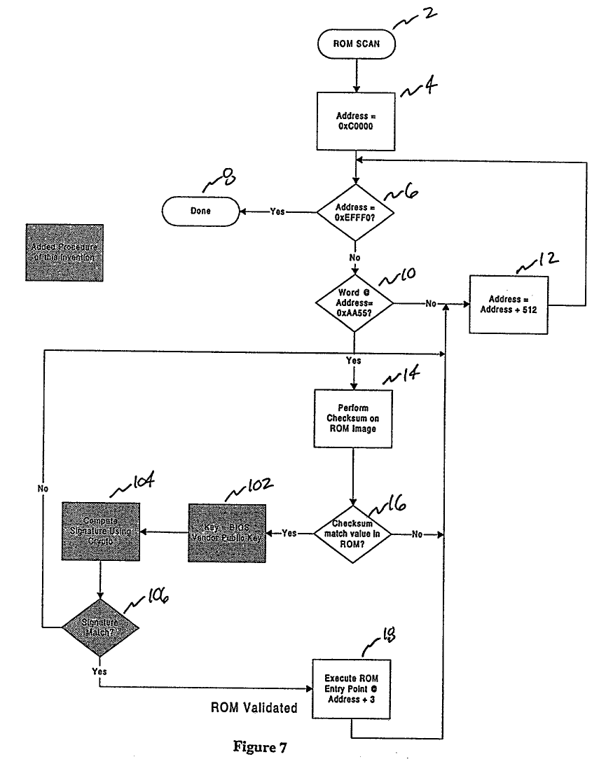

The second embodiment simplifies the runtime processing requirements since only a single key is required to be contained within the BIOS database, i.e. the BIOS vendor's public key. FIG. 7 illustrates the additional ROM scan steps needed for this second embodiment. Steps 2-14 are identical to the operation of the corresponding steps in FIG. 1 and a description of these steps will not be repeated here. Beginning at step 16, if there is a checksum match, the BIOS vendor's public key is read at step 102 and is used at step 104 to decrypt the signature. If the signature matches the computed hash digest at step 106, then the ROM image is loaded at step 18. Otherwise, the processing returns to step 12 in order to check the next possible address for an expansion ROM.

One drawback to this second method is that each release of an expansion ROM vendor's ROM program must be sent to the BIOS vendor, hashed, signed and returned back to the ROM vendor. As a practical matter, this procedure may be too cumbersome for certain applications. The advantage of the second embodiment, however, is that only one public key needs to stored in the system BIOS, reducing the amount of required non-volatile storage.

By incorporating the present invention into personal computer systems, BIOS vendors can provide a high-level of security to the systems, guaranteeing that no questionable expansion ROMs will ever be executed. In systems which support the “hot insertion” of expansion cards, the present invention can be invoked each time a new card is detected in order to ensure that only authorized ROM programs are loaded into the system. This provides a much greater level of system protection than is currently available.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A method for validating an expansion ROM card containing a ROM program, the method comprising the steps of:
creating a digital signature by signing (encrypting) the ROM program using a private key and a mutually agreed upon encryption algorithm;
storing the digital signature on the expansion ROM card;
decrypting the digital signature on the ROM card using a public key corresponding to the private key; and
comparing the decrypted digital signature with the ROM program;
wherein if the decrypted digital signature matches the ROM program, then the expansion ROM card is validated and loaded, and wherein if the decrypted digital signature does not match the ROM program, then the expansion ROM card is not validated and is not loaded.

2. The method of claim 1, wherein the step of creating a digital signature comprises the steps of:
creating a hash digest of the ROM program using a mutually agreed upon hashing algorithm; and
signing the hash digest using the private key and the mutually agreed upon encryption algorithm.

3. The method of claim 2, wherein the step of comparing comprises comparing the decrypted digital signature to a hash digest of the ROM image, wherein the hash digest is created using the mutually agreed upon hashing algorithm.

4. The method of claim 3, wherein each vendor of expansion ROM cards creates a unique digital signature using a unique private key.

5. The method of claim 4, wherein a system BIOS stores a public key corresponding to each ROM vendor's unique private key.

6. The method of claim 5, wherein each public key is used to decrypt (verify) the digital signature until a match is detected, or until all the public keys stored in the system BIOS have been used.

7. The method of claim 3, wherein a BIOS vendor creates the digital signature using a single private key.

8. The method of claim 7, wherein a system BIOS stores a single public key corresponding to the BIOS vendor's private key.

9. The method of claim 6, wherein the steps of decrypting the digital signature and of creating a hash digest of the stored ROM image are performed during a secure processor mode and in an associated secure memory area.

10. The method of claim 8, wherein the steps of decrypting the digital signature and of creating a hash digest of the stored ROM image are performed during a secure processor mode and in an associated secure memory area.

11. A method for validating an expansion ROM card containing a ROM program, the method comprising the steps of:
signing (encrypting) the ROM program to create a digital signature, the step of signing further comprising the steps of:
creating a first hash digest of the ROM program using a hashing algorithm known by both a ROM vendor and a BIOS vendor;
encrypting the first hash digest of the ROM program using a ROM vendor's private key, and an encryption algorithm known by both the ROM vendor and the BIOS vendor;
storing the digital signature on the expansion ROM card;
storing a public key corresponding to each ROM vendor's private key in a system BIOS;
decrypting the digital signature on the ROM card using a public key corresponding to the ROM vendor's private key, the public key stored in the system BIOS;
calculating a second hash digest of the ROM image using the hashing algorithm; and
comparing the decrypted digital signature with the second hash digest;
wherein if the decrypted digital signature matches the second hash digest, then the expansion ROM card is validated and loaded, and wherein if the decrypted digital signature does not match the hash digest, then the expansion ROM card is not validated and is not loaded.

12. The method of claim 11, wherein the steps of decrypting the digital signature and of creating a second hash digest of the stored ROM image are performed during a secure processor mode and in an associated secure memory area.

13. A method for validating an expansion ROM card containing a ROM program, the method comprising the steps of:
signing (encrypting) the ROM program to create a digital signature, the step of signing further comprising the steps of:
creating a first hash digest of the ROM program using a hashing algorithm;
encrypting the first hash digest of the ROM program using a BIOS vendor's private key, and an encryption algorithm;
storing the digital signature on the expansion ROM card;
storing a public key corresponding to the BIOS vendor's private key in a system BIOS;
decrypting the digital signature on the ROM card using the public key corresponding to the BIOS vendor's private key, the public key stored in the system BIOS;
calculating a second hash digest of the ROM image using the hashing algorithm; and
comparing the decrypted digital signature with the second hash digest;
wherein if the decrypted digital signature matches the hash digest, then the expansion ROM card is validated and loaded, and wherein if the decrypted digital signature does not match the hash digest, then the expansion ROM card is not validated and is not loaded.

14. The method of claim 13, wherein the steps of decrypting the digital signature and of creating a second hash digest of the stored ROM image are performed during a secure processor mode and in an associated secure memory area.
